(19) United States
(12) Patent Application Publication
(10) Pub. No.: US 2020/0143692 A1
(43) Pub. Date: May 7, 2020

(54) FLIGHT RESTRICTION DATA UPDATE METHOD AND APPARATUS

(71) Applicant: SZ DJI TECHNOLOGY CO., LTD., Shenzhen (CN)

(72) Inventors: Chang GENG, Shenzhen (CN); Hongzhu ZHOU, Shenzhen (CN); Senyao ZHENG, Shenzhen (CN); Yu CHEN, Shenzhen (CN)

(21) Appl. No.: 16/736,001

(22) Filed: Jan. 7, 2020

Related U.S. Application Data
(63) Continuation of application No. PCT/CN2017/093411, filed on Jul. 18, 2017.

(51) Int. Cl. G08G 5/00; B64C 39/02

(52) U.S. Cl. CPC G08G 5/0039; B64C 39/024; G08G 5/0069

(57) ABSTRACT

A flight restriction data update method includes sending an updating request to a server in response to an update triggering condition being satisfied, and receiving update data for a dynamic flight restriction database of a requesting device. The updating request includes current location information of the requesting device, and the update data is returned by the server according to the current location information.

### CROSS-REFERENCE TO RELATED APPLICATION

This application is a continuation of International Application No. PCT/CN2017/093411, filed on Jul. 18, 2017, the entire content of which is incorporated herein by reference.

### TECHNICAL FIELD

The present disclosure relates to unmanned aerial vehicle technology and, more particularly, to a method and apparatus for updating flight restriction data.

### BACKGROUND

Flight restriction zones include fixed flight restriction zones and temporary flight restriction zones. The fixed flight restriction zones include airports, prisons, and nuclear power plants, and other sensitive areas, and the nature of flight restrictions thereof do not change over time. Temporary flight restriction zones are often assigned due to events such as sports, political campaign activities, or fires. Unlike the fixed flight restriction zones, the temporary flight restriction zones are time sensitive. The temporary flight restriction zones are only valid during specific effective time periods and are invalid once the effective time periods expire. The ability of obtaining the flight restriction data in a timely manner is important for realizing safe flight of unmanned aerial vehicles.

### SUMMARY

In accordance with the disclosure, there is provided a flight restriction data update method including sending an updating request to a server in response to an update triggering condition being satisfied, and receiving update data for a dynamic flight restriction database of a requesting device. The updating request includes current location information of the requesting device, and the update data is returned by the server according to the current location information.

Also in accordance with the disclosure, there is provided a flight restriction data update apparatus including a processor. The processor is configured to send an updating request to a server in response to an update triggering condition being satisfied, and receive update data for a dynamic flight restriction database of a requesting device. The updating request includes current location information of the requesting device, and the update data is returned by the server according to the current location information.

### BRIEF DESCRIPTION OF THE DRAWINGS

To more clearly illustrate the technical solutions of the present disclosure, the accompanying drawings to be used in the description of the disclosed embodiments are briefly described herein. Obviously, the drawings in the following descriptions are merely certain embodiments of the present disclosure. For those of ordinary skill in the art, other drawings may also be obtained according to these drawings without creative labor.

FIG. 1 is a schematic diagram of an example unmanned aerial vehicle system according to some embodiments of the present disclosure.

FIG. 2 is a schematic diagram of another example unmanned aerial vehicle system according to some embodiments of the present disclosure.

FIG. 3 is a flow chart of an example method for updating flight restriction data at the requesting device side according to some embodiments of the present disclosure.

FIG. 4 is a flow chart of an example method for updating flight restriction data at the unmanned aerial vehicle side according to some embodiments of the present disclosure.

FIG. 5 is a flow chart of an example method for updating flight restriction data at the side of the ground terminal device that controls the unmanned vehicle according to some embodiments of the present disclosure.

FIG. 6 is a flow chart of an example method for updating flight restriction data at the server side according to some embodiments of the present disclosure.

FIG. 7 is a schematic diagram of an example apparatus for updating flight restriction data at the unmanned aerial vehicle side according to some embodiments of the present disclosure.

FIG. 8 is a schematic diagram of an example apparatus for updating flight restriction data at the ground terminal device side according to some embodiments of the present disclosure.

FIG. 9 is a schematic diagram of an example apparatus for updating flight restriction data at the server side according to some embodiments of the present disclosure.

### DETAILED DESCRIPTION OF THE EMBODIMENTS

Hereinafter, embodiments consistent with the present disclosure will be described clearly and completely with reference to drawings. Obviously, the embodiments described are only some but not all of the embodiments. Based on the disclosed embodiments and without contributing creative efforts, those having ordinary skill in the art may obtain other embodiments without departing from the scope of the present disclosure.

The method and apparatus for updating the flight restriction data according to the present disclosure will be described in detail below with reference to the accompanying drawings. The features of the embodiments described below may be combined with each other under the condition of no conflict.

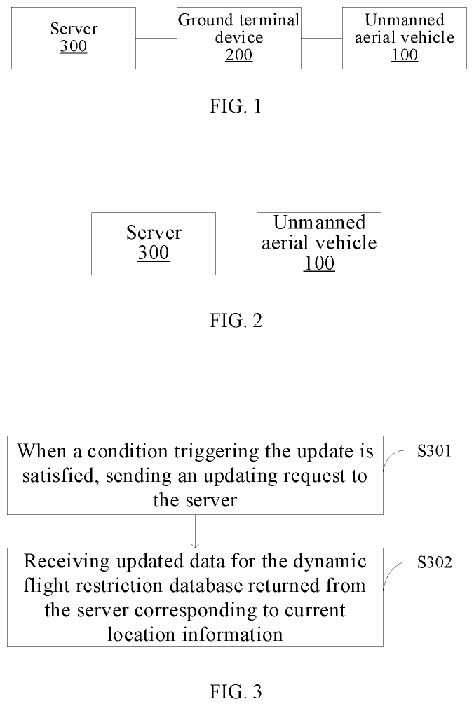

FIG. 1 schematically shows an example unmanned aerial vehicle (UAV) system consistent with the disclosure. As shown FIG. 1, the unmanned aerial vehicle system includes an unmanned aerial vehicle 100, a ground terminal device 200 configured to control the unmanned aerial vehicle 100, and a server 300. In the example shown in FIG. 1, the unmanned aerial vehicle 100 is in an unconnected state, and may communicate with the server 300 via the ground terminal device 200. In this disclosure, the unconnected state of the unmanned aerial vehicle 100 refers to that the unmanned aerial vehicle 100 is unable to connect to network or the unmanned aerial vehicle 100 is able to connect to the network but is inconvenient to connect to the network at the moment. Connecting to the network refers to connecting to a local area network through WiFi, base station, and/or other devices.

The ground terminal device 200 communicates with the unmanned aerial vehicle 100 by connecting to the network or relaying through a remote controller. The ground terminal device 200 may be a device, such as a smart phone, a tablet computer, or another smart device, with an APP (application software) installed.

FIG. 2 schematically shows another example unmanned aerial vehicle system consistent with the disclosure. In the example shown in FIG. 2, the unmanned aerial vehicle 100 is in a connected state. The unmanned aerial vehicle 100 may directly communicate with the server 300 without being relayed by the ground terminal device 200.

To ensure the flight safety, both the unmanned aerial vehicle 100 and the ground terminal device 200 that controls the unmanned aerial vehicle 100 need to obtain the flight restriction data. In some embodiments, both the unmanned aerial vehicle 100 and the ground terminal device 200 obtain the flight restriction data directly from the server 300. In some other embodiments, the ground terminal device 200 obtains the flight restriction data directly from the server 300, and then transmits to the unmanned aerial vehicle 100.

Specifically, when the unmanned aerial vehicle 100 is in the connected state, the unmanned aerial vehicle 100 can be a requesting device to directly request the flight restriction data from the server 300. When the unmanned aerial vehicle 100 is in the unconnected state, the ground terminal device needs to be the requesting device. The ground terminal device 200 obtains the flight restriction data from the server 300 and transmits to the unmanned aerial vehicle 100.

FIG. 3 is a flow chart of an example method for updating flight restriction data at the requesting device side according to some embodiments of the present disclosure. The requesting device is a device that requests the flight restriction data in the unmanned aerial vehicle 100 system, for example, the unmanned aerial vehicle 100 or the ground terminal device 200 that controls the unmanned aerial vehicle 100. The requesting device at least includes a dynamic flight restriction database to store the obtained temporary flight restriction zone information and frequently update the temporary flight restriction zone information. The requesting device includes a buffer memory, for example, an electrically erasable programmable read-only memory (EEPROM). The dynamic flight restriction database is stored in the buffer memory for the convenience of upgrading the dynamic flight restriction database.

When at least one of the dynamic flight restriction database of the ground terminal device 200 (i.e., the dynamic flight restriction database stored in the ground terminal device 200) and the dynamic flight restriction database of the unmanned aerial vehicle 100 (i.e., the dynamic flight restriction database stored in the unmanned aerial vehicle 100) includes the temporary flight restriction zone information or is a latest version, the unmanned aerial vehicle 100 is able to precisely comprehend the surrounding flight restriction to ensure the flight safety of the unmanned aerial vehicle 100. Under other circumstances, the unmanned aerial vehicle 100 is unable to precisely comprehend the surrounding flight restriction to ensure the flight safety of the unmanned aerial vehicle 100.

Referring to FIG. 3, the method of updating the flight restriction data includes the following.

At S301, when a condition triggering the update (also referred to as an “update triggering condition”) is satisfied, an updating request is sent to the server 300. The updating request includes current location information of the requesting device.

In some embodiments, the location information can include latitude and longitude, but is not limited to the latitude and longitude. In some other embodiments, the location information may include other parameters representing the location, for example, administrative area information.

At S302, update data for the dynamic flight restriction database returned from the server 300 corresponding to current location information is received.

After the server 300 receives the updating request, the server 300 extracts the update data for the dynamic flight restriction database of the requesting device corresponding to the current location information from a dynamically update database of the server 300 based on the current location information of the requesting device carried in the updating request, and sends back to the requesting device. As a result, the requesting device obtains the flight restriction data for the surrounding of the current location to ensure the flight safety of the unmanned aerial vehicle 100. In some embodiments, the dynamic flight restriction database of the requesting device stores the flight restriction data, and the update data for the dynamic flight restriction database of the requesting device is used to replace the flight restriction data stored in the dynamic flight restriction database of the requesting device. In some other embodiments, the dynamic flight restriction database of the requesting device does not store any data, and the update data for the dynamic flight restriction database of the requesting device is directly stored in the dynamic flight restriction database.

In some embodiments, the update data for the dynamic flight restriction database includes range information and a validity period of at least one temporary flight restriction zone. The range information of the temporary flight restriction zone includes parameters for determining a flight restriction range of the temporary flight restriction zone. In some embodiments, the range information of the temporary flight restriction zone includes periphery information of the temporary flight restriction zone. In some other embodiments, the range information of the temporary flight restriction zone includes a center location and a radius of the temporary flight restriction zone. In some embodiments, the range information of the temporary flight restriction zone may include other parameters for determining the flight restriction range of the temporary flight restriction zone.

Specifically, a format of the range information of the temporary flight restriction zone may be selected based on a shape of the temporary flight restriction zone. For example, the flight restriction zone is a regular circle. The range information of the circular temporary flight restriction zone may be represented by the periphery information of the temporary flight restriction zone or the center location and the radius of the temporary flight restriction zone. In another example, the temporary flight restriction zone has an irregular shape. The range information of the irregularly shaped temporary flight restriction zone may be represented by the periphery information of the temporary flight restriction zone. The validity period of the temporary flight restriction zone can include a staring time and an ending time. The temporary flight restriction zone is valid for the dynamic database of the current requesting device during a time period between the starting time and the ending time. During the validity period, the unmanned aerial vehicle 100 is forbidden to fly in the temporary flight restriction zone. Before the starting time or after the ending time, the temporary flight restriction zone is invalid. Outside the validity period, the unmanned aerial vehicle 100 is allowed to fly in the temporary flight restriction zone.

In some embodiments, the requesting device sends the updating request that carries the current location information of the requesting device to the server 300. The requesting device timely obtains the flight restriction data of the temporary flight restriction zone in the area where the requesting device is currently located from the server 300 to increase the accuracy and timeliness of the flight restriction data of the temporary flight restriction zone. At the same time, selecting the update data for the dynamic flight restriction database of the requesting device based on the location information may prevent the requesting device from requesting excessive amount of update data for the dynamic database.

Various embodiments of the method of updating the flight restriction data are described below with the unmanned aerial vehicle 100 and the ground terminal device 200 as the requesting device, respectively.

In some embodiments, the requesting device is the unmanned aerial vehicle 100. The unmanned aerial vehicle 100 includes a dynamic flight restriction database configured to store temporary flight restriction zone information obtained from the server 300 or the ground terminal device 200 that controls the unmanned aerial vehicle 100.

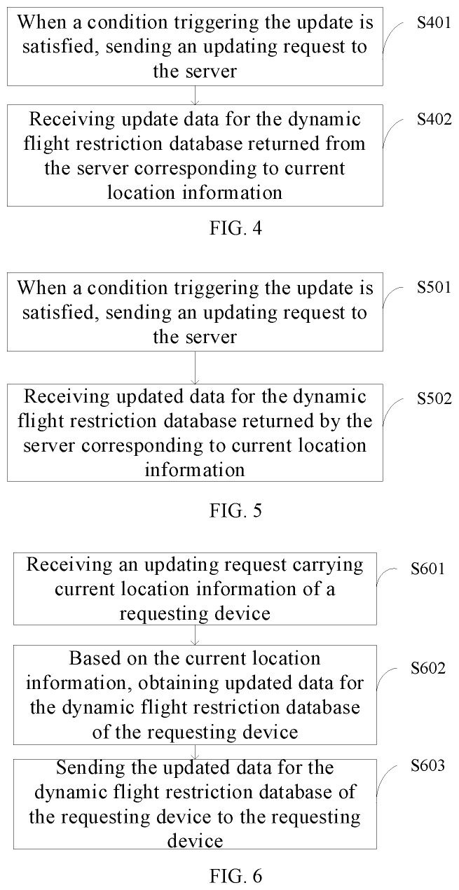

Referring to FIG. 3 and FIG. 4, when the requesting device is the unmanned aerial vehicle 100, processes S301 and S302 may be replaced by the following.

At S401: when a condition triggering the update is satisfied, an updating request is sent to the server 300, where the updating request includes current location information of the unmanned aerial vehicle 100.

At S402, update data for the dynamic flight restriction database returned from the server 300 corresponding to current location information is received.

In some embodiments, the unmanned aerial vehicle 100 sends the updating request that carries the current location information of the requesting device to the server 300. The unmanned aerial vehicle 100 timely obtains flight restriction data of temporary flight restriction zones in an area where the unmanned aerial vehicle 100 is currently located from the server 300 to increase the accuracy and timeliness of the flight restriction data of the temporary flight restriction zones. At the same time, selecting the update data for the dynamic flight restriction database of the unmanned aerial vehicle 100 based on the location information may prevent the unmanned aerial vehicle 100 from requesting excessive amount of update data for the dynamic database.

In some embodiments, the condition triggering the update in S401 includes detecting that the unmanned aerial vehicle 100 changes from an unconnected state to a connected state. When detecting that the unmanned aerial vehicle 100 changes from the unconnected state to the connected state, the unmanned aerial vehicle 100 sends an updating request carrying current location information of the unmanned aerial vehicle 100 to the server 300. On one hand, timely obtaining the update data for the dynamic database of the unmanned aerial vehicle 100 ensures the flight safety of the unmanned aerial vehicle 100 in the current location. On the other hand, using the current location information of the unmanned aerial vehicle 100 carried in the updating request ensures the accuracy of the update data for the dynamic database and avoids excessive amount of data.

In some embodiments, the condition triggering the update in S401 includes detecting that a time interval since a last updating request is sent is greater than or equal to a first preset time interval. The first preset time interval may be determined based on actual needs. For example, the first preset time interval is five minutes. The unmanned aerial vehicle 100 sends one updating request to the server 300 every five minutes. Because the location of the unmanned aerial vehicle 100 changes in real-time, sending the updating request from the unmanned aerial vehicle 100 to the server 300 at the first preset intervals ensures that the unmanned aerial vehicle 100 timely obtains the precise update data for the dynamic database of the unmanned aerial vehicle 100 from the server 300 and flies safely in the vicinity of the current location.

In some embodiments, the condition triggering the update in S401 includes detecting that the unmanned aerial vehicle 100 is ready to take off or end a flight. As such, the accuracy of the dynamic flight restriction database that the unmanned aerial vehicle 100 relies on for the current flight or the subsequent flight is ensured. Based on real-time flight status information, the unmanned aerial vehicle 100 determines whether the unmanned aerial vehicle 100 is ready to take off or end the flight. In one embodiment, the flight status information includes a flight take-off status and a flight ending status.

In some embodiments, the condition triggering the update in S401 may include other conditions triggering the update, and may be determined based on actual needs.

In some embodiments, the method of updating the flight restriction data further includes overwriting the dynamic flight restriction database with the update data for the dynamic flight restriction database to prevent the unmanned aerial vehicle 100 from running out of memory due to excessive amount of data. In some embodiments, after receiving the update data for the dynamic flight restriction database, the unmanned aerial vehicle 100 replaces the flight restriction data stored in the dynamic flight restriction database with the currently received update data. Overwriting ensures that the unmanned aerial vehicle 100 does not run out of memory, and prevents the dynamic flight restriction database of the unmanned aerial vehicle 100 from being too large.

In some embodiments, no data is stored in the dynamic flight restriction database of the unmanned aerial vehicle 100. After the unmanned aerial vehicle 100 receives the update data for the dynamic flight restriction database, the update data for the dynamic flight restriction database is directly saved into the dynamic flight restriction database of the unmanned aerial vehicle 100.

In some embodiments, the unmanned aerial vehicle 100 is in the connected state. The unmanned aerial vehicle 100 directly obtains the update data for the dynamic flight restriction database from the server 300. Before overwriting the update data for the dynamic flight restriction database into the dynamic flight restriction database, the method may also include receiving the update data for the dynamic flight restriction database sent from the server 300. In one embodiment, after receiving the update data for the flight restriction database sent from the server 300, the unmanned aerial vehicle 100 replaces the flight restriction data stored in the dynamic flight restriction database with the currently received update data. Overwriting ensures that the unmanned aerial vehicle 100 does not run out of memory and prevents the dynamic flight restriction database of the unmanned aerial vehicle 100 from growing out of control.

In some embodiments, the unmanned aerial vehicle 100 is in the unconnected state. The unmanned aerial vehicle 100 obtains the update data for the dynamic flight restriction database from the server 300 through the ground terminal device 200 that controls the unmanned aerial vehicle 100. Before overwriting the update data for the dynamic flight restriction database into the dynamic flight restriction database, the method may also include receiving the update data for the dynamic flight restriction database that the ground terminal device 200 obtains from the server 300. In one embodiment, after receiving the update data for the flight restriction database relayed by the ground terminal device 200, the unmanned aerial vehicle 100 replaces the flight restriction data stored in the dynamic flight restriction database with the currently received update data. Overwriting ensures that the unmanned aerial vehicle 100 does not run out of memory and prevents the dynamic flight restriction database of the unmanned aerial vehicle 100 from growing out of control.

In practical applications, the unmanned aerial vehicle 100 is unable to force to connect to the network. When the dynamic database version of the unmanned aerial vehicle 100 is too old or the center location of the flight restriction data in the dynamic database of the unmanned aerial vehicle 100 is too far away from the current location of the unmanned aerial vehicle 100, the data currently stored in the dynamic database of the unmanned aerial vehicle 100 may be out of date. The unmanned aerial vehicle 100 may be unable to fly safely based on the data currently stored in the dynamic database of the unmanned aerial vehicle 100.

The method of updating the flight restriction data also includes, when the data currently stored in the dynamic database is out of date, sending a first user notification to the ground terminal device 200 that controls the unmanned aerial vehicle 100 to notify the user that the dynamic flight restriction database of the unmanned aerial vehicle 100 is out of date. As a result, the user is reminded of connecting the unmanned aerial vehicle 100 to the network to obtain the update or connecting the ground terminal device 200 to the network to obtain the update, and the dynamic database of the unmanned aerial vehicle 100 is updated. The center location of the flight restriction data in the dynamic database refers to a center location of a maximum area formed by all temporary flight restriction zones in the dynamic flight restriction database.

The unmanned aerial vehicle 100 may determine the validity of the dynamic flight restriction database based on certain parameters of the current dynamic flight restriction database, for example, an updating time of the current dynamic flight restriction database and a center location of the flight restriction data in the current dynamic flight restriction database. The updating time of the dynamic flight restriction database can be a time when the server 300 returns the update data for the current dynamic flight restriction database, or a time when the unmanned aerial vehicle 100 receives the update data for the current dynamic flight restriction database. In general, the time when the server 300 returns the update data for the current dynamic flight restriction database is substantially the same as the time when the unmanned aerial vehicle 100 receives the update data for the current dynamic flight restriction database. The origin of the updating time may be the server 300 or the unmanned aerial vehicle 100. The center location may be obtained from communication detection equipment such as a GPS device or a base station, etc. The detection equipment may be disposed at the unmanned aerial vehicle 100.

In some embodiments, the method of updating the flight restriction data further includes obtaining an updating time of the current dynamic flight restriction database. The condition that the current dynamic flight restriction database is no longer valid includes that a time elapsed since a last updating time is greater than or equal to a second preset time interval, thereby indicating that the dynamic database of the unmanned aerial vehicle 100 needs to be updated timely. The second preset time interval may be determined based on actual needs. For example, the second preset time interval is configured to be 3 days. That is, the unmanned aerial vehicle 100 updates the dynamic flight restriction database at 3-day intervals to ensure that the unmanned aerial vehicle 100 can precisely determine the flight restrictions in the vicinity of the current location.

In some embodiments, the method of updating the flight restriction data further includes obtaining a center location of the flight restriction data in the current dynamic flight restriction database. The condition that the current flight restriction database is no longer valid includes that a distance between a current location of the unmanned aerial vehicle 100 and the center location is greater than or equal to a preset distance. The preset distance may be determined based on actual needs. For example, the preset distance is 100 meters. When the distance between a current location of the unmanned aerial vehicle 100 and the center location is greater than or equal to 100 meters, the unmanned aerial vehicle 100 is currently too far away from the center location. The temporary flight restriction zone information obtained surrounding the center location is no longer valid as the temporary flight restriction zone information corresponding to the current location of the unmanned aerial vehicle 100. As such, the dynamic database of the unmanned aerial vehicle 100 needs to be further updated.

In addition, the format of the first user notification is not limited by the present disclosure. For example, the first user notification may be in the form of a voice announcement or a dialog box, etc.

In some embodiments, the method of updating the flight restriction data further includes, when the unmanned aerial vehicle 100 changes from power-off to power-on, a request for obtaining the dynamic data is sent to the ground terminal device 200 that controls the unmanned aerial vehicle 100. As a result, the unmanned aerial vehicle 100 obtains the dynamic database from the ground terminal device 200 and replaces the current dynamic database of the unmanned aerial 100 with the dynamic database obtained from the ground terminal device 200. When the unmanned aerial vehicle 100 changes from power-off to power-on, the unmanned aerial vehicle 100 changes the validity of the dynamic database of the unmanned aerial vehicle 100 from unknown to known. During the power-off period, the dynamic database of the unmanned aerial vehicle 100 may become invalid due to the extended length of power-off or other factors. Thus, the database of the unmanned aerial vehicle 100 needs to be timely updated upon power-on of the unmanned aerial vehicle 100 to ensure the flight safety of the unmanned aerial vehicle 100.

The unmanned aerial vehicle 100 may also include a static flight restriction database for storing the fixed flight restriction zone information, thereby ensuring the flight safety of the unmanned aerial vehicle 100 from all aspects. In one embodiment, the unmanned aerial vehicle 100 includes a static database and a dynamic database for storing the fixed flight restriction zone information and the temporary flight restriction zone information, respectively. The fixed flight restriction zones rarely change while the temporary flight restriction zones change frequently. When the unmanned aerial vehicle 100 needs to update the flight restriction data, only one of the static database and the temporary database is selected to be updated, thereby avoiding excessive amount of data being updated every time.

In some embodiments, the unmanned aerial vehicle 100 includes a fixed memory space. Because the static flight restriction database rarely changes, the static flight restriction database is stored in the fixed memory space. The static flight restriction database may be configured in the unmanned aerial vehicle 100 ex-factory. When the static flight restriction database of the server 300 changes or there are other reasons for updating the static flight restriction database of the unmanned aerial vehicle 100 after the unmanned aerial vehicle 100 is shipped from the factory, the static flight restriction database of the unmanned aerial vehicle 100 may be updated by a firmware upgrade or other suitable methods.

At the unmanned aerial vehicle 100, the method of updating the flight restriction data further includes sending current version information of the static flight restriction database to the server 300 to ensure that the unmanned aerial vehicle 100 timely obtains relatively accurate fixed flight restriction zone information (including range information of the fixed flight restriction zones). Thus, the unmanned aerial vehicle 100 obtains the relatively accurate fixed flight restriction zone information. In one embodiment, the unmanned aerial vehicle 100 proactively notifies the server 300 of the current version information of the static flight restriction database of the unmanned aerial vehicle 100. The server 300 further determines whether the current static flight restriction database of the unmanned aerial vehicle 100 needs to be updated. In some embodiments, the version information may include a version number of the current static flight restriction database. The server 300 determines whether the current static flight restriction database of the unmanned aerial vehicle 100 needs to be updated based on the version number of the current static flight restriction database. In some embodiments, the version information may include an updating time of the current static flight restriction database. The server 300 determines whether the current static flight restriction database of the unmanned aerial vehicle 100 needs to be updated based on the updating time of the current static flight restriction database.

In some embodiments, when the version information of the current static flight restriction database of the unmanned aerial vehicle 100 is different from the version information of the static flight restriction database of the server 300, the server 300 may send the update data for the static flight restriction database of the unmanned aerial vehicle 100 (e.g., the entire data in the static flight restriction database of the server 300) to the unmanned aerial vehicle 100 to update the current static flight restriction database of the unmanned aerial vehicle 100. At the unmanned aerial vehicle 100, the method of updating the flight restriction data includes receiving the update data for the static flight restriction database sent from the server 300 and updating the static flight restriction database with the update data for the static flight restriction database. As a result, the static flight restriction database of the unmanned aerial vehicle 100 is updated, and the unmanned aerial vehicle 100 can obtain the relatively accurate fixed flight restriction zone information.

Further, formats of the data stored in the dynamic flight restriction database and the static flight restriction database are not limited by the present disclosure.

Further, the unmanned aerial vehicle 100 is in the connected state. When no request for the flight restriction data is made to the server 300 by the ground terminal device 200, the unmanned aerial vehicle 100 may send the update data for the dynamic database or the update data for the static database to the ground terminal device 200, such that the ground terminal device 200 is able to timely update the dynamic database or the static database of the ground terminal device 200. Thus, it is ensured that the flight restriction zone displayed by the ground terminal device 200 is accurate.

In one embodiment, the requesting device is the ground terminal device 200 that controls the unmanned aerial vehicle 100. The ground terminal device 200 includes a dynamic flight restriction database for storing temporary flight restriction zone information obtained from the server 300.

Referring to FIG. 3 and FIG. 5, when the requesting device is the ground terminal device 200, S301 and S302 are replaced by the following.

At S501, when a condition triggering the update is satisfied, an updating request is sent to the server 300. The updating request includes current location information of the ground terminal device 200 that controls the unmanned aerial vehicle 100.

At S502: update data for the dynamic flight restriction database returned from the server 300 corresponding to current location information is received.

In one embodiment, the ground terminal device 200 sends the updating request carrying the current location information of the ground terminal device 200, timely obtains the flight restriction data of the temporary flight restriction zones in the area where the ground terminal device is currently located from the server 300 and improves the accuracy and validity of the flight restriction data of the temporary flight restriction zones. At the same time, the update data for the dynamic flight restriction database of the ground terminal device 200 is filtered based on the location information and requesting excessive amount of update data for the dynamic database of the ground terminal device 200 is avoided.

In one embodiment, the condition triggering the update in S501 includes detecting that the unmanned aerial vehicle 100 is in the unconnected state. That is, when the ground terminal device 200 sends the updating request carrying current location information of the ground terminal device 200 to the server 300, the unmanned aerial vehicle 100 is in the unconnected state. The unmanned aerial vehicle 100 needs the ground terminal device 200 to request the update data for the dynamic database from the server 300, thereby ensuring the flight safety of the unmanned aerial vehicle 100.

In some embodiments, the condition triggering the update in S501 further includes detecting that the ground terminal device 200 changes from the unconnected state to the connected state. When detecting that the ground terminal device 200 changes from the unconnected state to the connected state, the ground terminal device 200 directly sends an updating request carrying current location information of the ground terminal device 200 to the server 300, timely updates the dynamic database of the ground terminal device 200 and prevents the dynamic database of the ground terminal device 200 from losing the validity.

In some embodiments, the condition triggering the update further includes detecting that the unmanned aerial vehicle 100 is ready to take off or end the flight, to ensure the accuracy of the dynamic flight restriction database for the current or subsequent flight. The ground terminal device 200 obtains flight status information in real-time, such that the flight status information of the unmanned aerial vehicle 100 is used to determine whether the unmanned aerial vehicle 100 is ready to take off or end the flight. In one embodiment, the flight status information includes a flight take-off status and a flight ending status.

In some embodiments, the condition triggering the update in S501 further includes detecting that the ground terminal device 200 changes from being disconnected with the unmanned aerial vehicle 100 to being connected with the unmanned aerial vehicle 100. When detecting that the ground terminal device 200 changes from being disconnected with the unmanned aerial vehicle 100 to being connected with the unmanned aerial vehicle 100, the ground terminal device 200 sends an updating request to the server 300 to timely update the dynamic database of the ground terminal device 200. Thus, the dynamic database of the unmanned aerial vehicle 100 can be updated timely, thereby ensuring the flight safety of the unmanned aerial vehicle 100.

In some embodiments, the condition triggering the update in S501 further includes receiving an instruction sent by the unmanned aerial vehicle 100 to instruct the ground terminal device 200 to update the dynamic database. It is more practical to have the unmanned aerial vehicle 100 trigger the ground terminal device 200 to update the dynamic database.

In some embodiments, the condition triggering the update in S501 further includes detecting that a time interval since a last updating request is sent is greater than or equal to a third preset time interval. As a result, the dynamic database of the ground terminal device 200 is timely updated. The third time interval is determined based on actual needs. For example, the third time interval is 10 minutes. The ground terminal device 200 sends the updating request to the server 300 at 10-minute intervals, i.e., every 10 minutes.

In some embodiments, the condition triggering the update in S501 may include other conditions triggering the update and may be determined based on actual needs.

In some embodiments, after receiving the update data for the dynamic flight restriction database returned from the server 300 corresponding to the current location information, the method further includes overwriting the dynamic flight restriction database with the update data for the dynamic flight restriction database to prevent the ground terminal device 200 from running out of memory due to excessive amount of data. In some embodiments, after receiving the update data for the dynamic flight restriction database, the ground terminal device 200 replaces the flight restriction data stored in the dynamic flight restriction database of the ground terminal device 200 with the currently received update data. Overwriting ensures that the ground terminal device 200 does not run out of memory and prevents the dynamic flight restriction database of the ground terminal device 200 from growing out of control.

In some embodiments, no data is stored in the dynamic flight restriction database of the ground terminal device 200. After the ground terminal device 200 receives the update data for the dynamic flight restriction database, the update data for the dynamic flight restriction database is directly saved into the dynamic flight restriction database of the ground terminal device 200.

In one embodiment, the ground terminal device 200 needs to connect to the server 300 from an area having a network connection and obtains the update data for the dynamic database of the ground terminal device 200 from the server 300. Further, after the update data for the dynamic flight restriction database returned from the server 300 corresponding to the current location information is received, the method further includes sending the current dynamic flight restriction database to the unmanned aerial vehicle 100 so that the unmanned aerial vehicle 100 can timely update the dynamic flight restriction database of the unmanned aerial vehicle 100 and determine the flight restriction scenarios in the surrounding area. Specifically, the ground terminal device 200 may send the current dynamic flight restriction database to the unmanned aerial vehicle 100 in an area having no network connection.

In some embodiments, sending the current dynamic flight restriction database to the unmanned aerial vehicle 100 is executed immediately after overwriting the dynamic flight restriction database with the update data for the dynamic flight restriction database. After updating the dynamic database of the ground terminal device 200, the ground terminal device 200 sends the updated dynamic database of the ground terminal device 200 to the unmanned aerial vehicle 100, to timely update the dynamic database of the unmanned aerial vehicle 100.

In some embodiments, sending the current dynamic flight restriction database to the unmanned aerial vehicle 100 is executed when it is detected that the ground terminal device 200 changes from being disconnected with the unmanned aerial vehicle 100 to being connected with the unmanned aerial vehicle 100, and request failure information returned from the server 300 corresponding to the current updating request is received. When the ground terminal device 200 fails to update the database and detects that the unmanned aerial vehicle 100 is connected with the ground terminal device 200, the ground terminal device 200 sends the current dynamic database of the ground terminal device 200 to the unmanned aerial vehicle 100 to timely update the database of the unmanned aerial vehicle 100.

In some embodiments, sending the current dynamic flight restriction database to the unmanned aerial vehicle 100 is executed after a request for obtaining the dynamic data sent by the unmanned aerial vehicle 100 is received. It is more flexible and practical that the unmanned aerial vehicle 100 proactively obtains the dynamic database of the ground terminal device 200 to update the dynamic database of the unmanned aerial vehicle 100.

The ground terminal device 200 also includes a static flight restriction database to ensure the flight safety of the unmanned aerial vehicle 100 from all aspects. In one embodiment, the ground terminal device 200 includes a static database and a dynamic database for storing the fixed flight restriction zone information and the temporary flight restriction zone information, respectively. The fixed flight restriction zones rarely change while the temporary flight restriction zones change frequently. When the ground terminal device 200 needs to update the flight restriction data, only one of the static database and the temporary database is selected to be updated, thereby avoiding excessive amount of data being updated each time.

In one embodiment, the ground terminal device 200 includes a fixed memory space. Because the static flight restriction database rarely changes, the static flight restriction database is stored in the fixed memory space. The static flight restriction database may be configured in the unmanned aerial vehicle 100 ex-factory. When the static flight restriction database of the server 300 changes or there are other reasons for updating the static flight restriction database of the unmanned aerial vehicle 100 after the unmanned aerial vehicle 100 is shipped from the factory, the static flight restriction database of the unmanned aerial vehicle 100 may be updated by a firmware upgrade or other suitable methods.

At the ground terminal device 200, the method of updating the flight restriction data further includes: sending current version information of the static flight restriction database to the server 300 to ensure that the ground terminal device 200 timely obtains relatively accurate fixed flight restriction zone information (including the range information of the fixed flight restriction zones). Thus, the unmanned aerial vehicle 100 obtains the relatively accurate fixed flight restriction zone information. The ground terminal device 200 proactively notifies the server 300 of the current version information of the static flight restriction database of the ground terminal device 200. The server 300 further determines whether the current static flight restriction database of the ground terminal device 200 needs to be updated. In some embodiments, the version information may include a version number of the current static flight restriction database. The server 300 determines whether the current static flight restriction database of the ground terminal device 200 needs to be updated based on the version number of the current static flight restriction database. In some embodiments, the version information may include an updating time of the current static flight restriction database. The server 300 determines whether the current static flight restriction database of the ground terminal device 200 needs to be updated based on the updating time of the current static flight restriction database.

In some embodiments, when the version information of the current static flight restriction database of the ground terminal device 200 is different from the version information of the static flight restriction database of the server 300, the server 300 may send the update data for the static flight restriction database of the ground terminal device 200 (e.g., the entire data in the static flight restriction database of the server 300) to the ground terminal device 200 to update the current static flight restriction database of the ground terminal device 200. At the ground terminal device 200, the method of updating the flight restriction data includes receiving the update data for the static flight restriction database sent from the server 300 and updating the static flight restriction database with the update data for the static flight restriction database. As a result, the static flight restriction database of the ground terminal device 200 is updated, and the ground terminal device 200 can obtain the relatively accurate fixed flight restriction zone information.

In some embodiments, the ground terminal device 200 may obtain the updating time or the version information of the static flight restriction database of the unmanned aerial vehicle 100 periodically or irregularly to compare with the updating time or the version information of the static flight restriction database of the ground terminal device 200. The ground terminal device 200 notifies the user to upgrade the static flight restriction database of the unmanned aerial vehicle 100 or the ground terminal device 200, to avoid the risk of flying the unmanned aerial vehicle 100 unsafely or the issue of incorrect display on the ground terminal device 200 due to the out-of-date static flight restriction database of the ground terminal device 200 or the out-of-date static flight restriction database of the unmanned aerial vehicle 100.

When the updating time of the static flight restriction database of the ground terminal device 200 is more recent than the updating time of the static flight restriction database of the unmanned aerial vehicle 100 or the version number of the static flight restriction database of the ground terminal device 200 is higher than the version number of the static flight restriction database of the unmanned aerial vehicle 100, the static flight restriction database of the ground terminal device 200 is newer than the static flight restriction database of the unmanned aerial vehicle 100, and the static flight restriction database of the unmanned aerial vehicle 100 needs to be updated. When the updating time of the static flight restriction database of the unmanned aerial vehicle 100 is more recent than the updating time of the static flight restriction database of the ground terminal device 200 or the version number of the static flight restriction database of the unmanned aerial vehicle 100 is higher than the version number of the static flight restriction database of the ground terminal device 200, the static flight restriction database of the unmanned aerial vehicle 100 is newer than the static flight restriction database of the ground terminal device 200, and the static flight restriction database of the ground terminal device 200 needs to be updated.

In some embodiments, the method of updating the flight restriction data further includes, when the updating time of the static flight restriction database of the ground terminal device 200 is more recent than the updating time of the static flight restriction database of the unmanned aerial vehicle 100 or the version number of the static flight restriction database of the ground terminal device 200 is higher than the version number of the static flight restriction database of the unmanned aerial vehicle 100, generating a second user notification to notify the user to update the static flight restriction database of the unmanned aerial vehicle 100. It is flexible to use the second user notification to notify the user to upgrade the static flight restriction database of the unmanned aerial vehicle 100.

In some embodiments, the method of updating the flight restriction data further includes, when the updating time of the static flight restriction database of the ground terminal device 200 is more recent than the updating time of the static flight restriction database of the unmanned aerial vehicle 100 or the version number of the static flight restriction database of the ground terminal device 200 is higher than the version number of the static flight restriction database of the unmanned aerial vehicle 100, sending a triggering signal to the unmanned aerial vehicle 100 to trigger the unmanned aerial vehicle 100 to update the static flight restriction database stored in the unmanned aerial vehicle 100 with the static flight restriction database of the ground terminal device 200. Using the triggering signal to directly force the unmanned aerial vehicle 100 to upgrade the static flight restriction database and force the user to upgrade can improve the flight safety of the unmanned aerial vehicle 100. After receiving the triggering signal, the unmanned aerial vehicle 100 directly locks flight to upgrade the static flight restriction database of the unmanned aerial vehicle 100. After the update of the static flight restriction database of the unmanned aerial vehicle 100 is completed, the unmanned aerial vehicle 100 can be controlled to continue to fly.

In some embodiments, the method of updating the flight restriction data further includes, when the updating time of the static flight restriction database of the unmanned aerial vehicle 100 is more recent than the updating time of the static flight restriction database of the ground terminal device 200 or the version number of the static flight restriction database of the unmanned aerial vehicle 100 is higher than the version number of the static flight restriction database of the ground terminal device 200, generating a third user notification to notify the user to update the static flight restriction database of the ground terminal device 200. It is flexible to use the third user notification to notify the user to upgrade the static flight restriction database of the ground terminal device 200. In one embodiment, the static flight restriction database of the ground terminal device 200 needs to be updated. After generating the third user notification, the ground terminal device 200 receives an instruction returned from the user to confirm the update. The ground terminal device 200 obtains the update data for the static flight restriction database of the ground terminal device 200 from the server 300. Thus, the static flight restriction database of the ground terminal device 200 is upgraded.

Further, after the third user notification is generated, the method further includes, when an instruction of cancelling the update is received, generating a fourth user notification to notify the user that the ground terminal device 200 is in a risky state of displaying, and the user is properly warned. When the ground terminal device 200 receives the instruction of cancelling the update, the static flight restriction database of the unmanned aerial vehicle 100 is newer than the static flight restriction database of the ground terminal device 200, and the user chooses not to update the static flight restriction database of the ground terminal device 200. At this point, the ground terminal device 200 continues to use the current static flight restriction database and incorrect displaying may occur.

In addition, the formats of the second user notification, the third user notification, and the fourth user notification are not limited by the present disclosure. For example, the second user notification, the third user notification, and the fourth user notification may be in the form of a voice announcement or a dialog box, etc.

In addition, the formats of the data stored in the dynamic flight restriction database and the static flight restriction database are not limited by the present disclosure.

FIG. 6 is a flow chart of an example method for updating flight restriction data at the server side according to some embodiments of the present disclosure. The server 300 includes at least a dynamic flight restriction database.

Referring to FIG. 6, the method of updating the flight restriction data includes the following.

At S601, an updating request carrying current location information of a requesting device is received.

In one embodiment, the requesting device is an unmanned aerial vehicle 100 or a ground terminal device 200 that controls the unmanned aerial vehicle 100.

In some embodiments, the location information can include latitude and longitude, but is not limited to the latitude and longitude. In some other embodiments, the location information may include other parameters representing the location, for example, administrative area information.

At S602, update data for the dynamic flight restriction database of the requesting device is obtained based on the current location information.

Specifically, obtaining the update data (S602) may include obtaining area information of the unmanned aerial vehicle 100 based on the current location information and obtaining the update data of the dynamic flight restriction database of the requesting device based on the dynamic flight restriction database of the server 300 and the area information. Based on the current location information of the requesting device, the server 300 selects the flight restriction data in the area where the requesting device is located from the dynamic flight restriction database of the server 300. The selected update data is highly accurate. The selection process prevents the requesting device from obtaining excessive amount of update data for the dynamic flight restriction database of the requesting device.

In some embodiments, the area information includes country information of an area where the requesting device is located. Based on the current location information of the requesting device, the server 300 obtains the dynamic flight restriction database for the country where the requesting device is currently located from the dynamic flight restriction database of the server 300, such that the unmanned aerial vehicle 100 can fly safely in the country where the unmanned aerial vehicle 100 is currently located.

In some embodiments, the area information includes a range of an area within a specified length from the current location of the requesting device. The specified length is determined based on actual needs. For example, the specified length is configured to be 10 km. Based on the current location information of the requesting device, the server 300 obtains temporary flight restriction zone information in a circular area having the current location of the requesting device as the center and 10 km as the radius from the dynamic flight restriction database of the server 300. When a temporary flight restriction zone is partially located in the circular area having the current location of the requesting device as the center and 10 km as the radius (e.g., an edge portion of the temporary flight restriction zone, half of the temporary flight restriction zone, or another portion of the temporary flight restriction zone is located in the circular area), the server 300 may obtain the information about the entire temporary flight restriction zone and include it in the update data for the dynamic flight restriction database of the requesting device, thereby improving the flight safety of the unmanned aerial vehicle 100. In some other embodiments, the area information may be represented by other information. The present disclosure does not limit the format of the area information. The area information may be determined based on actual needs.

In some embodiments, obtaining the area information for the requesting device based on the current location information includes, based on a preset handover policy, switching the area information to the country information of the area where the requesting device is located or the range of the area within the specified length from the current location of the unmanned aerial vehicle 100. The flexibility of choosing the area information satisfies the safety need of flying the unmanned aerial vehicle 100. In one embodiment, to satisfy the safety need of flying the unmanned aerial vehicle 100 in various countries, the handover policy includes, based on the country information of the requesting device, switching the area information to the country information of the area where the requesting device is located or the range of the area within the specified length from the current location of the unmanned aerial vehicle 100. For example, when the requesting device is in China, the area information is switched to the country information of the area. When the requesting device is in the USA, the area information is switched to the range of the area within the specified length from the current location of the unmanned aerial vehicle 100.

The update data for the dynamic flight restriction database of the requesting device includes range information and a validity period of the temporary flight restriction zones corresponding to the area information in the dynamic flight restriction database of the server 300. The description of the range information and the validity period of the temporary flight restriction zones may be referred to previous embodiments and will not be repeated herein.

At S603, the update data for the dynamic flight restriction database of the requesting device is sent to the requesting device.

In some embodiments, the requesting device sends the updating request carrying the current location information of the requesting device to timely obtain the flight restriction data of the temporary flight restriction zones in the area where the requesting device is currently located from the server 300, thereby improving the accuracy and timeliness of the flight restriction data of the temporary flight restriction zones. At the same time, selecting the update data for the dynamic flight restriction database of the requesting device based on the location information also prevents the requesting device from obtaining excessive amount of update data for the dynamic flight restriction database.

In some embodiments, at the same time of sending the update data for the dynamic flight restriction database of the requesting device to the requesting device, the method further includes sending a center location and/or an updating time corresponding to the update data for the dynamic flight restriction database of the requesting device to the requesting device. The center location of the flight restriction data in the dynamic database refers to a center location of a maximum area formed by all temporary flight restriction zones in the dynamic flight restriction database. The updating time corresponding to the update data for the dynamic flight restriction database refers to a time when the server 300 sends the dynamic flight restriction database. Alternatively, the updating time corresponding to the update data for the dynamic flight restriction database refers to a time when the requesting device receives the dynamic flight restriction database sent from the server 300.

In general, the time when the server 300 returns the update data for the current dynamic flight restriction database is substantially the same as the time when the unmanned aerial vehicle 100 receives the update data for the current dynamic flight restriction database. The origin of the updating time may be the server 300 or the unmanned aerial vehicle 100. The center location may be obtained from communication detection equipment such as a GPS device or a base station, etc. The detection equipment may be disposed at the unmanned aerial vehicle 100 or the ground terminal device 200. In some embodiments, sending the center location and/or the updating time corresponding to the update data for the dynamic flight restriction database of the requesting device to the requesting device may be executed after sending the update data for the dynamic flight restriction database of the requesting device to the requesting device.

In some embodiments, the method further includes receiving an instruction of storing the temporary flight restriction zone information to add the temporary flight restriction zone information to the dynamic flight restriction database of the server 300. As a result, when there is a change in the temporary flight restriction zone, the dynamic flight restriction database of the server 300 is timely updated to ensure the validity of the dynamic flight restriction database of the server 300. The temporary flight restriction zone information includes range information and a validity period, etc.

In some embodiments, the method further includes, upon detecting that the current temporary flight restriction zone information is invalid, deleting the current temporary flight restriction zone information from the dynamic flight restriction database of the server 300 to timely delete the invalid or out-of-date temporary flight restriction zone information from the dynamic flight restriction database of the server 300. The temporary flight restriction zone information includes the range information and the validity period of the temporary flight restriction zone.

In some embodiments, detecting that the current temporary flight restriction zone information is invalid includes detecting that a current time is beyond the validity period of the current temporary flight restriction zone. That is, the end time of the validity period of the current flight restriction zone is earlier than the current time. There is no need to enforce the current temporary flight restriction zone. The current temporary flight restriction zone information is invalid. In some embodiments, detecting that the current temporary flight restriction zone information is invalid includes receiving an instruction indicating that the current temporary flight restriction zone is invalid. In this case, it is flexible for the user to proactively cancel the validity of the temporary flight restriction zone.

In addition, the server 300 also includes a static flight restriction database to store fixed flight restriction zone information (e.g., range information of the fixed flight restriction zone). The server 300 includes both the static database and the dynamic database to store the fixed flight restriction zone information and the temporary flight restriction zone information, respectively. The fixed flight restriction zones rarely change while the temporary flight restriction zones change frequently. When the unmanned aerial vehicle 100 or the ground terminal device 200 requests to update the flight restriction data, the configuration of the static data base and the dynamic database allows the convenience of selecting the update data and prevents the unmanned aerial vehicle 100 or the ground terminal device 200 from obtaining excessive amount of update data in each update.

Similarly, the formats of the data stored in the dynamic database and the static database are not limited by the present disclosure.

In some embodiments, the method further includes receiving the current version information of the static flight restriction database sent from the requesting device for the server 300 to determine the validity of the static database of the requesting device. Based on the version information of static flight restriction database of the requesting device, the server 300 determines the validity of the static database of the requesting device to decide whether to send the static flight restriction database of the server 300 to the requesting device, to timely update the static flight restriction database of the requesting device.

In some embodiments, the method further includes sending the static flight restriction database of the server 300 to the requesting device, such that the requesting device timely updates the static flight restriction database. In some embodiments, sending the static flight restriction database of the server 300 to the requesting device is executed when the version number of the static flight restriction database of the requesting device is lower than the version number of the static flight restriction database of the server 300. As a result, the requesting device timely obtains the latest version of the static flight restriction database to ensure the flight safety of the unmanned aerial vehicle 100. In some embodiments, sending the static flight restriction database of the server 300 to the requesting device is immediately executed after the static flight restriction database of the server 300 is updated. After updating the static flight restriction database, the server 300 immediately sends the updated static flight restriction database of the server 300 to the requesting device to timely update the static flight restriction database of the requesting device.

Corresponding to the updating methods of various embodiments, the present disclosure also provides an apparatus of updating the flight restriction data. The apparatus of updating the flight restriction data will be described below from the perspectives of the unmanned aerial vehicle 100, the ground terminal device 200, and the server 300, respectively.

Corresponding to the method of updating the flight restriction data at the side of the unmanned aerial vehicle 100, the present disclosure provides an apparatus of updating the flight restriction data. The apparatus is applicable to the unmanned aerial vehicle 100.

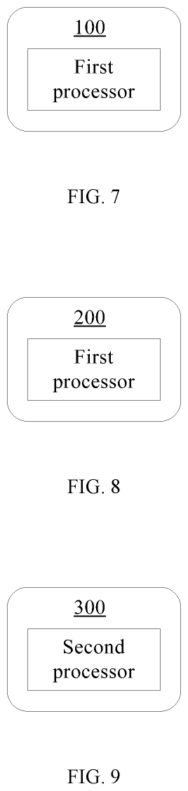

Referring to FIG. 7, the apparatus of updating the flight restriction data includes a first processor. The first processor is used to execute the method of updating the flight restriction data at the side of the unmanned aerial vehicle 100.

In some embodiments, the first processor includes one processor. The one processor is configured to execute the method of updating the flight restriction data at the side of the unmanned aerial vehicle 100.

In some embodiments, the first processor includes a plurality of processors. The plurality of processors are configured to coordinately execute the method of updating the flight restriction data at the side of the unmanned aerial vehicle 100.

In some embodiments, the first processor may be a controller of a special control device or a flight controller of the unmanned aerial vehicle 100.

For the undescribed portion of the function of the first processor, reference may be made to the same or similar portion of the method of updating the flight restriction data at the side of the unmanned aerial vehicle 100 and details thereof will not be repeated here.

Corresponding to the method of updating the flight restriction data at the side of the ground terminal device 200, the present disclosure provides an apparatus of updating the flight restriction data. The apparatus is applicable to the ground terminal device 200.

Referring to FIG. 8, the apparatus of updating the flight restriction data includes a first processor. The first processor is used to execute the method of updating the flight restriction data at the side of the ground terminal device 200.

In some embodiments, the first processor includes one processor. The one processor is configured to execute the method of updating the flight restriction data at the side of the ground terminal device 200.

In some embodiments, the first processor includes a plurality of processors. The plurality of processors are configured to coordinately execute the method of updating the flight restriction data at the side of the ground terminal device 200.

For the undescribed portion of the function of the first processor, reference may be made to the same or similar portion of the method of updating the flight restriction data at the side of the ground terminal device 200 and details thereof will not be repeated here.

Corresponding to the method of updating the flight restriction data at the side of the server 300, the present disclosure provides an apparatus of updating the flight restriction data. The apparatus is applicable to the server 300.

Referring to FIG. 9, the apparatus of updating the flight restriction data includes a second processor. The second processor is used to execute the method of updating the flight restriction data at the side of the server 300.

In some embodiments, the second processor includes one processor. The one processor is configured to execute the method of updating the flight restriction data at the side of the server 300.

In some embodiments, the second processor includes a plurality of processors. The plurality of processors are configured to coordinately execute the method of updating the flight restriction data at the side of the server 300.

For the undescribed portion of the function of the second processor, reference may be made to the same or similar portion of the method of updating the flight restriction data at the side of the server 300 and details thereof will not be repeated here.

The present disclosure also provides a computer storage medium. The computer storage medium can be included in an apparatus consistent with the disclosure, such as one of the example apparatuses described above. The computer storage medium stores program instructions that, when executed by a corresponding processor (such as one of the example processors described above), cause the processor to execute a method of updating the flight restriction data consistent with the disclosure, such as one of the above-described example methods.

In the description of the present specification, reference terms such as “one embodiment”, “some embodiments”, “illustrative embodiment”, “example”, “specific example”, “some example” and the like mean that specific features, structures, materials, or characteristics described in connection with the embodiments or examples are included in at least one embodiment or example of the present disclosure. In the present specification, the illustrative representation of the reference terms does not necessarily refer to the same embodiment or example. Moreover, the described features, structures, materials or characteristics may be combined in a desired manner in any one or more embodiments or examples.

Any process or method description in the flowcharts or otherwise described herein may be interpreted as a module, a segment or a portion of program codes representing executable instructions implementing one or more steps of a specific logical function or process. And the scope of the preferred embodiments of the present disclosure includes additional implementations, in which the functions or processes may or may not be performed in the order as illustrated or described. For example, the functions or processes may be performed in a substantially simultaneous manner or in an opposite order depending on the functions involved. It should be understood by those skilled in the art to which the embodiments of the present disclosure pertain.

The logics or steps represented in the flowcharts or otherwise described herein, for example, may be considered as an ordered list of executable instructions for implementing the logical functions, and may be embodied in any computer readable medium for use by or in conjunction with an instruction execution system, apparatus, or device (such as a computer-based system, a processor-based system, or other system that fetches instructions from an instruction execution system, apparatus, or device and executes instructions). In the present specification, “computer readable medium” may be any apparatus that contains, stores, communicates, propagates, or transports program instructions for use in or in conjunction with an instruction execution system, apparatus, or device. More specific examples (non-exhaustive list) of the computer readable medium include electrical connections having one or more wires (electronic devices), portable computer disk cartridges (magnetic devices), random access memories (RAM), read-only memories (ROM), erasable programmable read-only memories (EPROM or flash memories), fiber optic devices, and portable compact disk read-only memories (CDROM), etc. In addition, the computer readable medium may even be program instruction printed papers or other desired media. For example, the program instruction printed on papers or other desired media may be optically scanned, edited, interpreted, or if appropriate, processed in other suitable manner to electronically obtain the program instructions. The program instructions may then be stored in the computer memory.

Individual steps or portions of the methods may be implemented in hardware, software, firmware, or a combination thereof. In various embodiments of the present disclosure, multiple steps or methods may be implemented in software or firmware stored in a memory and executed by a suitable instruction execution system. For example, when implemented in hardware, as in other embodiments, it may be implemented by any one or combination of the following techniques well known in the art: discrete logic circuits with logic gates for implementing logic functions of digital signals, application specific integrated circuits having suitable combinational logic gates, programmable gate arrays (PGA), field programmable gate arrays (FPGA), or the like.

Those skilled in the art can understand that all or part of the forgoing methods can be carried out by program instruction related hardware. The program may be stored in a computer readable storage medium. When executed, the program causes the related hardware (such as a processor) to execute part or the entirety of a method consistent with the disclosure, such as one of the above-described example methods.

In addition, individual function units of various embodiments may be integrated into one processing module. Each function unit may be physically separated. Two or more function units may be integrated into one module. The integrated module may be in the form of hardware function module or software function module. When the integrated module is in the form of software function module, and is sold or used as a separate product, the software function module may be stored in a computer readable storage medium.

The storage medium may be a read-only memory, a magnetic disk or an optical disk. The above description is only some embodiments of the present disclosure and is not intended to limit the scope of the present disclosure. Those having ordinary skill in the art may appreciate various modifications and changes. Any modifications, equivalent substitutions, and improvements made within the spirit and principle of the present disclosure should be included in the scope of the present disclosure.

What is claimed is:

1. A flight restriction data update method comprising:
sending an updating request to a server in response to an update triggering condition being satisfied, the updating request including current location information of a requesting device; and
receiving update data for a dynamic flight restriction database of the requesting device, the update data being returned by the server according to the current location information.

2. The method of claim 1, wherein the requesting device includes an unmanned aerial vehicle.

3. The method of claim 2, wherein the update triggering condition includes at least one of:
detecting that the unmanned aerial vehicle changes from an unconnected state to a connected state;
detecting that the unmanned aerial vehicle is ready to take off or end a flight; or
detecting that a time interval since a last updating request is sent is greater than or equal to a preset time interval.

4. The method of claim 2, further comprising:
overwriting the dynamic flight restriction database with the update data.

5. The method of claim 4, wherein the update data is received directly from the server or received from a ground terminal device that obtained the update data from the server, the ground terminal device being configured to control the unmanned aerial vehicle.

6. The method of claim 2, further comprising:
in response to the dynamic flight restriction database being currently invalid, sending a user notification to a ground terminal device configured to control the unmanned aerial vehicle.

7. The method of claim 1, wherein the requesting device includes a ground terminal device configured to control an unmanned aerial vehicle.

8. The method of claim 7, wherein the update triggering condition includes at least one of:
detecting that the unmanned aerial vehicle is in an unconnected state;
detecting that the ground terminal device changes from an unconnected state to a connected state;
detecting that the unmanned aerial vehicle is ready to take off or end the flight;
detecting that the ground terminal device changes from being disconnected with the unmanned aerial vehicle to being connected with the unmanned aerial vehicle;
receiving an instruction sent from the unmanned aerial vehicle to instruct the ground terminal device to update the dynamic flight restriction database; or
detecting that a time interval since a last updating request is sent is greater than or equal to a preset time interval.

9. The method of claim 7, further comprising, after receiving the update data:
overwriting the dynamic flight restriction database with the update data.

10. The method of claim 7, further comprising, after receiving the update data:
sending the current dynamic flight restriction database to the unmanned aerial vehicle.

11. The method of claim 10, wherein sending the current dynamic flight restriction database to the unmanned aerial vehicle is executed:
immediately after overwriting the dynamic flight restriction database with the update data;
after detecting that the ground terminal device changes from being disconnected with the unmanned aerial vehicle to being connected with the unmanned aerial vehicle and receiving request failure information returned from the server; or
after receiving a request for obtaining dynamic data sent from the unmanned aerial vehicle.

12. The method of claim 1, wherein the requesting device also includes a static flight restriction database.

13. A flight restriction data update apparatus comprising:
a processor configured to:
send an updating request to a server in response to an update triggering condition being satisfied, the updating request including current location information of a requesting device; and
receive update data for a dynamic flight restriction database of the requesting device, the update data being returned by the server according to the current location information.

14. The apparatus of claim 13, wherein the requesting device includes an unmanned aerial vehicle.

15. The apparatus of claim 14, wherein the update triggering condition includes at least one of:
detecting that the unmanned aerial vehicle changes from an unconnected state to a connected state;
detecting that the unmanned aerial vehicle is ready to take off or end a flight; or
detecting that a time interval since a last updating request is sent is greater than or equal to a preset time interval.

16. The apparatus of claim 13, wherein the requesting device includes a ground terminal device configured to control an unmanned aerial vehicle.

17. The apparatus of claim 16, wherein the update triggering condition includes at least one of:
detecting that the unmanned aerial vehicle is in an unconnected state;
detecting that the ground terminal device changes from an unconnected state to a connected state;
detecting that the unmanned aerial vehicle is ready to take off or end the flight;
detecting that the ground terminal device changes from being disconnected with the unmanned aerial vehicle to being connected with the unmanned aerial vehicle;
receiving an instruction sent from the unmanned aerial vehicle to instruct the ground terminal device to update the dynamic flight restriction database; or
detecting that a time interval since a last updating request is sent is greater than or equal to a preset time interval.

18. The apparatus of claim 16, wherein the processor is further configured to, after receiving the update data, overwrite the dynamic flight restriction database with the update data.

19. The apparatus of claim 16, wherein the processor is further configured to, after receiving the update data, send the current dynamic flight restriction database to the unmanned aerial vehicle.

20. The apparatus of claim 19, wherein the processor is further configured to send the current dynamic flight restriction data base to the unmanned aerial vehicle:
immediately after overwriting the dynamic flight restriction database with the update data;
after detecting that the ground terminal device changes from being disconnected with the unmanned aerial vehicle to being connected with the unmanned aerial vehicle and receiving request failure information returned from the server; or
after receiving a request for obtaining dynamic data sent from the unmanned aerial vehicle.
